(19) United States
(12) Patent Application Publication
(10) Pub. No.: US 2007/0260001 A1
(43) Pub. Date: Nov. 8, 2007

(54) METHOD FOR FLATTING THERMOPLASTIC POLYMERS AND PAINTS

(76) Inventor: Lorenzo COSTA, Arese (MI) (IT)

Correspondence Address: NOTARO AND MICHALOS, 100 DUTCH HILL ROAD, SUITE 110, ORANGEBURG, NY, 10962-2100, US

(21) Appl. No.: 11/697,442

(22) Filed: Apr. 6, 2007

Related U.S. Application Data
(63) Continuation-in-part of application No. 10/924,032, filed on Aug. 23, 2004.

(30) Foreign Application Priority Data
Mar. 30, 2004 (IT) MI2004A 000628

(51) Int. Cl. C08L 91/00

(52) U.S. Cl. 524/313; 525/221

(57) ABSTRACT

This invention concerns a method for flatting moulded thermoplastic polymers pieces, with this flatting being obtained by means of a mechanism for reflecting/refracting light on the surface achieved by adding particles used to create a specific geometric pattern on the surface of the moulded piece. Said method comprises the addition of particles to said thermoplastic polymers and is characterised by the fact that said particles to be added to the thermoplastic polymers are coated with a carrier that has a melting point that is lower than the melting point for said thermoplastic polymers and paints.

### CROSS REFERENCE TO RELATED PATENT APPLICATIONS

This application is a continuation-in-part of U.S. patent application Ser. No. 10/924,032, filed Aug. 23, 2004, which is incorporated here by reference, which claims priority on Italian application number MI2004A 000628, filed Mar. 30, 2004, which priority claim is repeated here.

### FIELD AND BACKGROUND OF THE INVENTION

This invention concerns a method and the product derived from applying this method for flatting moulded thermoplastic polymers parts with this flatting being obtained by means of a mechanism for reflecting/refracting light on the surface achieved by adding particles used to create a specific geometric pattern on the surface of the moulded part.

There are several procedures for flatting both moulded thermoplastic polymers parts in order to obtain a matt surface finish.

Some procedures provide for adding compounds that form chemical bonds with the polymer to be flatted. The technique described in the EP 0 369 200 (General Electric) patent is of this type and is used to obtain moulded or thermoformed parts of thermoplastic polymer, including PVC, with a matt surface by using a polyorganosiloxane that forms a graft copolymer with the polyvinyl polymer to be flatted. Flatting is basically obtained by forming chemical bonds (grafting) between the base polymer (PVC) and the additive (polyorganosiloxane).

Another method, of the same type that provides for the formation of chemical bonds, is described in the U.S. Pat. No. 6,476,128 (General Electric) patent, according to which it is possible to control the glossiness of the surface of moulded thermoplastic parts (such as PVC and a graft copolymer made up of elastomeric and rigid blocks) by adjusting the cross-linkage density of the chemical bonds between these blocks.

The above-mentioned methods involve various drawbacks, due basically to the fact that flatting is obtained by means of a chemical reaction between the thermoplastic polymer and the flatting agent. This fact first of all means that the flatting agent must be able to react chemically with the thermoplastic polymer, and in addition the process must be carried out in such a way as to create optimum conditions for obtaining this chemical reaction. The fact that the flatting agent must be able to react, means in turn that each thermoplastic polymer requires specific flatting agents, thereby drastically reducing the possibility of one specific flatting agent being adapted for treating a wide range of thermoplastic polymers.

In addition, the fact that the original thermoplastic polymer has undergone chemical reactions during its transformation, means that it is different from the original, with the result that its physical characteristics are changed and the possibility of recycling is compromised to a greater or lesser extent.

It is known that by adding small size particles (a few microns in diameter) during extrusion of thermoplastic polymers, moulded or blow moulded parts are obtained with matt surfaces, this flatting having been obtained by means of a mechanism of reflecting/refracting the light produced by the roughness caused by the particles that appear on the surface of the part. However attempt thus far have produced disappointing results, as the particles are not evenly distributed over the surface of the moulded part. More specifically, lumps are formed that will then cause spots on the surface of moulded parts.

This phenomenon is due to the fact that the particles tend to aggregate in such a way that the subsequent mixing in the extruder, is not able to separate them.

### SUMMARY OF THE INVENTION

This invention aims to resolve the drawbacks indicated above, proposing a method, and the product derived from this method, according to claims 1 and 13 respectively, and that make it possible to obtain moulded thermoplastic polymer parts by adding coated particles to the thermoplastic polymer or the paint. The procedure involved in this invention makes it possible to obtain parts through injection moulding, blow moulding, or calendering, whose surface is even in terms of appearance and touch as the particles are spread uniformly over the surface.

The method and derived product, covered by this invention, can be accomplished by using these coated particles, whose preparation is the subject of a concurrent patent application lodged by the same applicant.

### BRIEF DESCRIPTION OF THE DRAWINGS

This invention will now be described with reference to the figures enclosed in which:

FIG. 1 shows powder granules of the thermoplastic polymer to be moulded coated using a second polymer that encapsulates these particles;

FIGS. 2 (a, b, c, d) show how these particles migrate during coalescence of the thermoplastic polymer granules;

FIGS. 3 (a, b, c) show how the particles appear on the surface during mould injection; and

FIG. 4 shows the path the particles take during the formation of a parison.

### DESCRIPTION OF THE PREFERRED EMBODIMENTS

The procedure covered by this invention provides for adding to a thermoplastic polymer in powder form, to be injection moulded, blow moulded, or calendered or to powder coating material, some particles coated with an organic compound layer, which we will call the “carrier” as its task is to carry the particles to the surface of the moulded part, this carrier being chemically compatible with the thermoplastic polymer to be moulded.

More particularly, the method for flatting thermoplastic polymers in powder form according to the present invention comprises the steps of:
a) mixing at least a compound (1) selected from the group consisting of thermoplastic polymer materials in powder form along with a compound (2) selected from the group consisting of matting agent particles coated with a carrier; the said mixing being carried out at a temperature at which no melting of any of the said compounds takes place; and
b) heating the mixture obtained in step (a) at least up to the temperature of melting of said compound (1), but less than that of the matting agent;
   provided that the carrier is selected from compounds having a melting temperature of at least 30° C. below compound (1) and the matting agent is selected from compounds having a melting or decomposition temperature higher than that of compound (1).

In the present description, the term “polymer” embraces both homopolymers and copolymers, the term “copolymer” embraces linear copolymers, graft copolymers and monomers as well.

Compound (1) is every type of thermoplastic polymers; suitable polymers are olefin polymers, in particular α-olefin polymers, halogenated vinyl polymers, vinylidene polymers, styrene polymers and acrylic polymers. Examples of α-olefin polymers are polymers of α-olefins selected from ethylene, propylene, butene-1 and mixture of said α-olefins; ethylene polymers are preferred, in particular LDPE among ethylene hompolymers. Also preferred are copolymers of ethylene and at least one comonomer selected from the group consisting of acetate esters, such as vinyl acetate, acrylate esters, such as methyl acrylate, butyl acrylate, i.e. EVA, EBAC, EMAC copolymers. Typically, the said copolymers have comonomers in an amount ranging up to about 35 wt %.

Examples of halogenated vinyl polymers are polyvinyl chloride (PVC) and polyvinyl dichloride (PVDC). Preferred PVC exhibits a K-value ranging from 40 to 90.

As to styrene polymers, preferred styrene homopolymers are high impact styrerene homopolymers (HIPS). Suitable examples of styrene copolymers are those comprising at least a comonomer selected from the group consisting of acrylonitrile and butadiene. Preferred examples are acrylonitrile-butadiene-styrene (ABS) copolymers and styrene acrylonitrile (SAN) copolymers.

Examples of acrylic copolymers are those comprising at least a comonomer selected from the group consisting of acrylic acid, acrylate esters, acrylonitrile, styrene such as, and acrylonitrile-styrene-acrylate (ASA) copolymers.

Said matting agent particles are preferably made of thermoplastic polymers, which may also be cross-linked, or thermosetting polymers.

Preferably, the particle sizes of said matting agent particles are between 5 and 300 microns.

The said matting agent particles suitable in the present invention are well-known per se and also commercially available.

The said thermoplastic polymers as matting agent have preferably a melting or decomposition temperature equal to or higher than 140° C., preferably higher than 145° C.

The said polymers particles are made of polymers preferably selected from the group consisting of polyurethane, polyurea or poly(urethane-urea) and mixtures thereof, in particular thermoplastic ones. Typically said polymers exhibit a melting temperature, and/or decomposition temperature, over 140° C., preferably higher than 145° C., such as ranging from 140 to 200° C.

The said matting agent particles should preferably have a glass transition temperature that is at least equal to the melting point of the thermoplastic polymer to be moulded and must in any event not be damaged by the process temperature.

In the case of polyureas and polyurethanes, a variety of conventional chain extenders, such as diols, triols and diamines, triamines, can be used in preparing suitable polymers. Conventional chain extenders are molecules having two or more reactive functional groups (reactive sites) which will react with the reactive moieties of the polymers. The reactive moieties are typically present at the ends of the polymer oligomers as a result of routine synthesis, but the reactive moieties can be located at locations other than the ends. These reactive moieties can be hydroxyl (OH) groups or amine (NH₂) groups, but can include any of several other reactive groups which can then react with another functional group on the chain extender.

More particularly, polyurethanes are generally chain extended urethanes made by the reaction (a) of one or more polyisocyanate compound(s) or urethane prepolymer with (b) an active-hydrogen-containing compound, such as one or more polyol terminated intermediates.

Compounds (a), i.e. polyisocyanate compounds and urethane prepolymers, are compounds having an isocyanate group portion undergoing a urea-bond formation to crosslink or harden into a polymer.

Practical examples of said polyisocyanate compounds usable for the synthesis of fine polyurethane particles or fine polyurethane gel particles suitable in the present invention include those containing two isocyanate groups, such as tolylene diisocyanate, 4,4′-diphenylmethane diisocyanate, xylene diisocyanate, metaxylene diisocyanate, 1,6-hexamethylene diisocyanate, lysine diisocyanate, 4,4′-methylene-bis(cyclohexyl isocyanate), methylcyclohexane-2,4-(or -2,6-)-diisocyanate, 1,3-bis(isocyanatomethyl)cyclohexane, isophorone diisocyanate, trimethylhexamethylene diisocyanate, biueret, allophanate and dimeric acid diisocyanate.

Practical examples of active-hydrogen-containing compounds usable in the present invention include those reactive with isocyanate compounds, such as ethylene glycol, propylene glycol, 1,4-butanediol, 1,5-pentanediol, 1,6-hexanediol, octanediol, neopentyl glycol, glycerin, trimethylolpropane, hexanetriol, triethanolamine, pentaerythritol, ethylenediamine, propylamine, butylamine, 1,4-benzenethiol, sorbitol, polypropylene glycol, polyethylene glycol, polyethylene adipate, polybutylene adipate, polytetramethylene glycol, polyhexamethylene adipate, poly-.epsilon.-caprolactone, and polyhexamethylene carbonate. They can be used singly, in combination, or as copolymers. These active-hydrogen-containing compounds have a weight average molecular weight of preferably 100-10,000, more preferably 500-7,000.

Eligible urethane prepolymers as component (a) may be those which are derivable from the reaction of the above-mentioned polyols and polyisocyanates.

In the production of polyurethane, the isocyanate group in the polyisocyanates and the hydroxyl group in the polyol are indicatively in a stoichiometric ratio of 50:1 to 2:1, preferably 30:1 to 2:1, more preferably 10:1 to 1.2:1.0. The ratio is determined on the compounds employed and the properties required for the resulting product that means varying the soft segment or chain extender or isocyanate molecule the thermoplastic particles have different crystalline/amorphous ratios or, in other words, a melting or decomposition temperature, which affects refractive/reflective index and therefore gloss.

Polyurethanes may be prepared under conditions known in the art; that is, by reacting a hydroxyl compound with a polyisocyanate at a temperature of 50° C.-100° C. and under atmospheric pressure.

Fine polyurethane particles or fine polyurethane gel particles suitable for the present invention can be obtained by subjecting a polyisocyanate compound and an active-hydrogen-containing compound to emulsion polymerization in an inert liquid in the presence of colloidal polyurea particles serving as an emulsifier. The fine polyurethane particles or fine polyurethane gel particles so obtained have surfaces covered with the colloidal polyurea particles.

The above-mentioned carrier is a compound that should have a melting temperature that is at least a few tens of degrees lower than the melting point of the thermoplastic polymer to be moulded, preferably at least 30° C., more preferably at least 50° C., below the melting temperature of compound (1).

The said carrier is, typically, made of an organic compound selected from the group consisting of:

(i) α-olefin polymers, in particular ethylene polymers;

(ii) styrene polymers, such as SAN and ABS copolymers, and acrylic copolymers;

(iii) mono- and polyesters of saturated or unsaturated C₄-C₃₀ fatty acids with branched or linear C₁-C₂₀ alcohols; and

(iv) mixtures thereof.

The said olefin polymers (i) are preferably polymers having a melting point equal to or less than about 120° C. Typically the said olefin polymers (i) are selected from the group consisting of:
polyethylene, amorphous ethylene polymers, such as LDPE or VLDPE and copolymers of ethylene with at least one comonomer selected from the group consisting of: vinyl acetate, acrylate esters, such as methyl acrylate and butyl acrylate; and
amorphous or low crystalline isotactic polypropylene as well as its copolymer with other α-olefins, such as ethylene, butene-1.

Preferred examples of copolymers of ethylene with vinyl acetate, which are known as EVA copolymers, are those contained from 4 to 35, preferably 20-35, wt % of vinyl acetate, such as 21 wt % of vinyl acetate.

Preferred examples of acids and alcohols suitable to obtain the above-mentioned esters as follows: palmitic acid, adipic acid, citric acid, stearic acid, cetyl alcohol, ethyl alcohol, esyl alcohol, glycerol.

Practical examples of mono- and polyesters used as carrier are as follows: diethyl adipate, dioctyl adipate, ethyl citrate, octyl palmitate, isooctyl palmitate, myristyl palmitate, cetyl stearyl palmitate, purified castor oils, hydrogenated castor oils, olein, stearine, triglycerides.

When the carrier is a mixture, it can be a mixture of two or more polymer or esters or at least one polymer and at least one ester. Any ratio between said components is suitable.

It will also be clearly understood from the above description that the carrier is not chemically linked to the matting agent. The particles and carrier are chosen on the basis of the thermoplastic polymer to be injection moulded, blow moulded, or calendered. However, there must always be sufficient chemical compatibility between the carrier and said thermoplastic polymer otherwise good adhesion will not be obtained between said carrier and said moulding polymer, the other characteristics must be chosen on the basis of the process parameters.

Practical examples of components used in the process according to the present invention are the following combinations:

I)
compound (1) is selected from the group consisting of ethylene polymers, particularly amorphous ethylene homopolymers, more particularly low density polyethylene;
matting agent is selected from the group consisting of polyurethane having a ratio of soft segments to isocyanates of 1:50, preferably 1:30; and
carrier is selected from the group consisting of mono- and polyesters of saturated or unsaturated C₄-C₃₀ fatty acids with branched or linear C₁-C₂₀ alcohols and ethylene copolymers, in particular EVA copolymers, having the comonomers ranging from 20 to 35 wt % for example, and their mixtures.

The process step (a) is typically carried out at a temperature ranging from 25 to 110° C. The process step (b) is typically carried out at a temperature ranging from 120 to 220° C.

II)
compound (1) is ethylene copolymers, in particular EVA copolymers, having the comonomers ranging from 4 to 35 wt % for example;
matting agent is a polyurethane having a ratio of soft segments to isocyanates of 1:50, preferably 1:30; and
carrier Is selected from the group consisting of mono- and polyesters of saturated or unsaturated C₄-C₃₀ fatty acids with branched or linear C₁-C₂₀ alcohols.
   The process step (a) is typically carried out at a temperature ranging from 25 to 110° C. The process step (b) is typically carried out at a temperature ranging from 120 to 180° C.

III)
compound (1) is a styrene polymer, such as HIPS homopolymers, ABS and SAN copolymers;
matting agent is selected from the group consisting of polyurethane/polyurea particles having a ratio of soft segments to isocyanate of 1:15, preferably 1:10; and
carrier Is selected from the group consisting of mono- and polyesters of saturated or unsaturated C₄-C₃₀ fatty acids with branched or linear C₁-C₂₀ alcohols.
   The process step (a) is typically carried out at a temperature ranging from 25 to 75° C. The process step (b) is typically carried out at a temperature ranging from 180 to 230° C.

When dealing with a thermoplastic polymer to be moulded, the coated particles are added to the thermoplastic polymer in order to obtain a powder mass, which is loaded into the hopper on the extruder for example. Then the powder mass thus obtained is heated until the carrier melts.

With the configuration described and the characteristics listed, during heating the carrier melts completely while the thermoplastic polymer to be moulded is still solid. In this situation the carrier is significantly fluid, as it is at a temperature a good deal higher than its melting point. Thus, due to the chemical compatibility between the carrier and the thermoplastic polymer to be moulded and the mixing effect generated by the extruder's screw, the carrier itself, and therefore the particles it carries, completely covers the powder granules of the thermoplastic polymer to be moulded, as these granules are still solid.

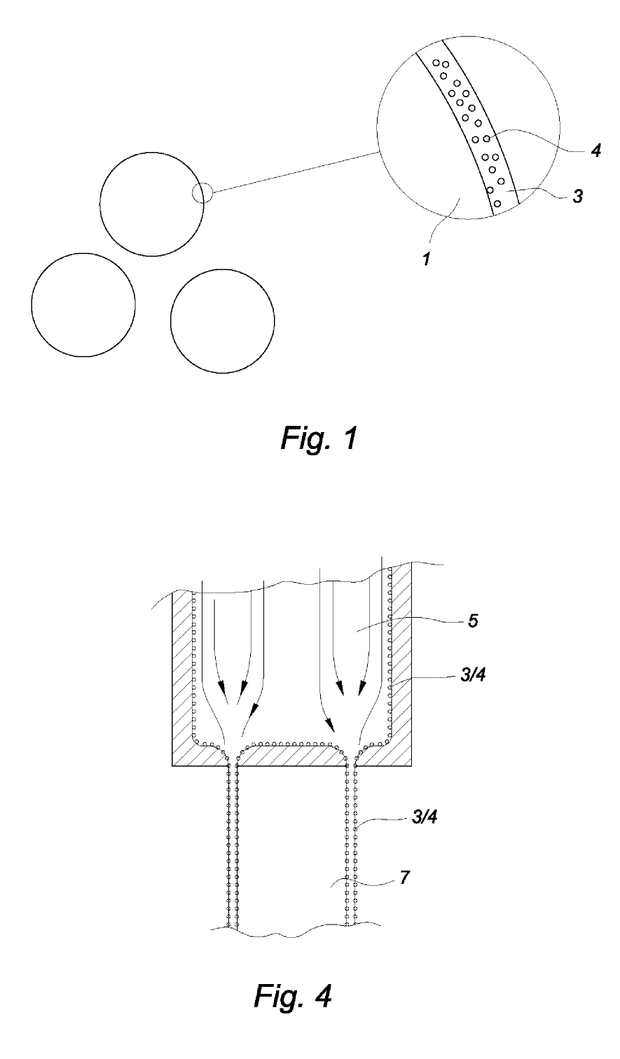

This situation is shown in FIG. 1, in which (1) indicates the thermoplastic polymer granules coated with the carrier (3) in which the particles (4) are encapsulated.

As the temperature increases, the granules of thermoplastic polymer to be moulded begin to soften before melting. Under these conditions, while the thermoplastic polymer to be moulded is still very viscous, the carrier, being at a temperature well above its melting point, is very fluid and, when the granules of thermoplastic polymer to be moulded begin to coalesce, they form spherical granules of ever increasing size, the carrier tends to be pushed out of the contact zone and ends up spreading itself, along with the particles it is carrying, on the outer surface of the molten masses.

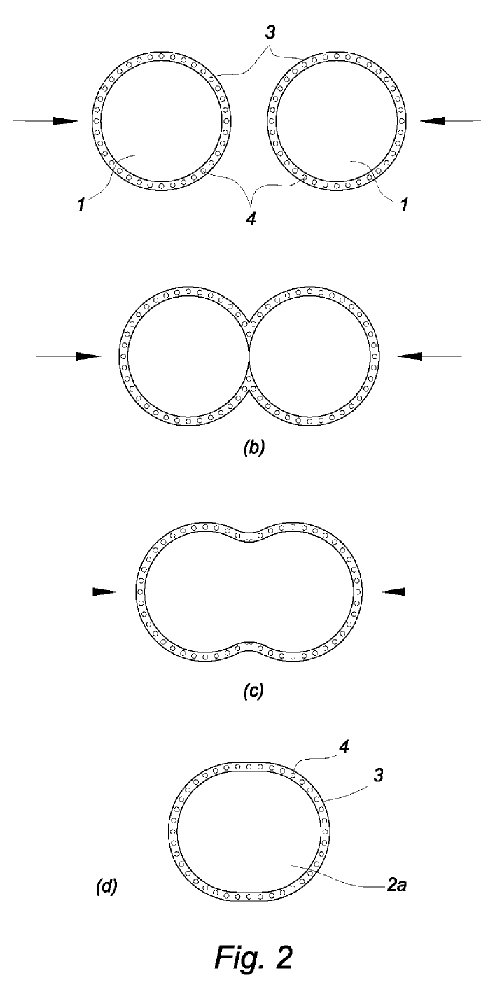

This stage is illustrated in FIGS. 2 (a, b, c, d) in which two granules of thermoplastic polymer (2) are shown, coated with the carrier (3) encapsulating the particles (4), which move towards one another (FIG. 2a), come into contact (FIG. 2b) and finally, as the temperature continues to increase, begin combining (FIG. 2c) to form a small single molten mass (20) (FIG. 2d).

The process described, which has started in the extruder, continues in the injection nozzle and the mould, with the result that the carrier and the encapsulated particles migrate almost completely towards the surface of the moulded part, while inside the moulded part only small traces remain of both the carrier, and the particles.

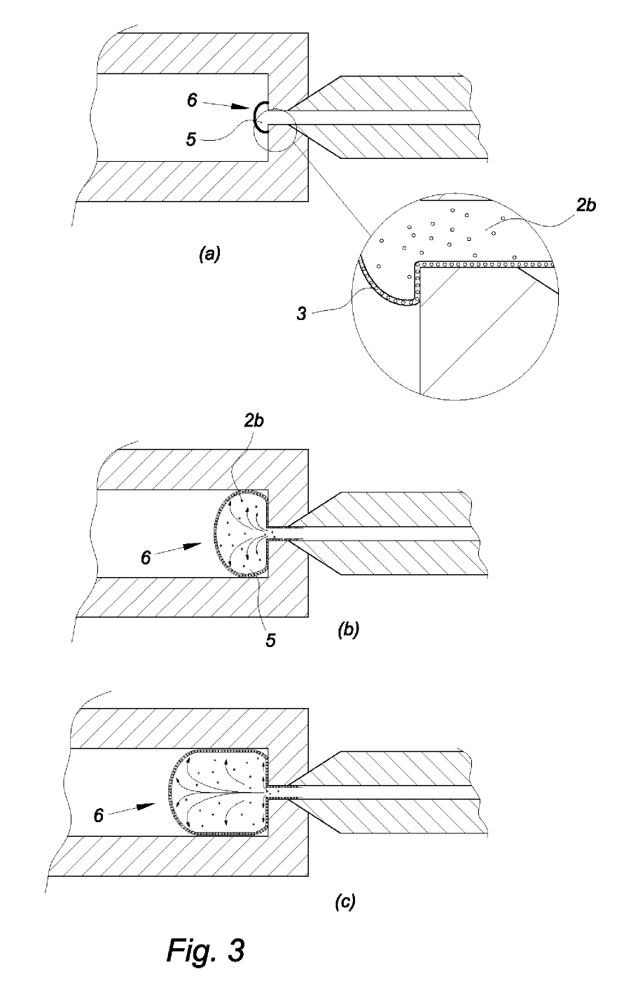

FIGS. 3 (a, b, c) show how the carrier and the encapsulated particles appear on the surface. In FIG. 3a the molten mass (5) coming out of the extruder is still relatively rich in carrier with encapsulated particles, while the front (6) of this molten mass (5), moving towards the mould, is in its turn rich in carrier and particles.

As this front (6) moves forward in the mould, pushed on by new molten mass (5) injected by the extruder, the inclusions of carrier (3) and particles (4) follow the paths marked by the arrows and appear on the front surface (6), and, thus, deposit themselves in the inside walls of the mould.

Obviously, when forming a parison, this stage of the process occurs before the extrusion die, thus, as shown in FIG. 4, the carrier with the encapsulated particles is deposited on the outer and inner surfaces of the parison.

When extruding a mass in a paste state for calendering moulding, the carrier and the particles migrate towards the surface of the mass in exactly the same way as with the mechanism involved in screw mixing.

At this stage the importance of the carrier is clear. In fact, it is precisely the presence of a polymer with a melting point that is significantly lower than the melting point for the thermoplastic polymer to be moulded that makes the mobility of the particles possible. First of all they are separated through the carrier, since, as it melts, it acts as a lubricant allowing the particles to flow in relation to one another, and this is the condition that is required to separate the particles. But the carrier also mainly allows the particles to migrate, first towards the surface of the molten mass and then towards the surface of the parts moulded. It is clear in fact, as shown in FIGS. 2 (a, b, c, d); that the particles that are between two granules of thermoplastic polymer that have just melted, would be encapsulated between them if there were no fluid means of transport, the carrier, to allow them to slip out of the molten mass as it increases in size, with the obvious result that a much higher quantity of particles would have to be added, without reaching the surface of the moulded part with the evenness and uniformity made possible by the presence of the carrier.

Obviously at the process temperature, neither the carrier, nor the particles must undergo any sort of alteration. If there is a possibility of oxidation or degradation of the polymer or of the carrier or of the microspheres or a mixture of these will be necessary to add to the formulation the right amount of antioxidants. This means to add a mixture of the following products: hindered phenolic antioxidant that provides very low volatility and excellent resistance to extraction from polymer compounds or sulfur containing antioxidant for use during polymer processing or high performance organophosphite or mixture of these. In addition the glass transition temperature for the particles should preferably be equal or superior to the process temperature.

The particles to be used should preferably be microspheres made of polyurethane-polyurea as these have the greatest flatting and tactile characteristics for the same grain size and light fastness.

Still among the organic compounds, these particles may be acrylic, cellulose, or polyamide particles. Inorganic particles may however be used as well, such as silica, mixed potassium and aluminium silicates, or talc particles.

As mentioned above, the melting point of the carrier must be at least a few tens of degrees lower than the process temperature, at least 30, preferably 50° C., so that the carrier will be very fluid at the process temperature, as this characteristic favours migration of the particles towards the surface of the molten mass.

In case of calendering moulding, a carrier can also be chosen where desirable that is fluid at room temperature. This moulding process is used mainly for plasticised PVC with liquid plasticisers. In this case some advantage can be drawn from using the plasticiser as the carrier thereby reducing the amount of plasticiser to be added to the polymer. Some plasticisers used in this case include: dioctyl phthalate, diisobutyl phthalate, diisonyl phthalate, adipate, citrate and cycloaliphatic esters.

When using a liquid carrier therefore, the coated particles are in the form of a more or less fluid paste, suitable to be added to the polymer by means of appropriate pumps.

As far as the particles are concerned, in-depth test has been carried out that makes it possible to provide more detailed indications as to the effects that can be obtained by suitable selection of these.

The test was carried out using as matting agents thermoplastic polyurethane-polyurea microspheres (commercialized under the trademark Decosphaera® by Supercolori) exhibiting a melting temperature of about 150° C. It is based on a mixture of polyols having molecular weight between 1000 and 5000 MW and aliphatic isocyanate in a stoichiometric OH/NCO ratio of from 1:1.2 to 1:10 to obtain complete curing. and as compound (I) a PVC with k value of 87. The type of carrier and matting agent are set out in the tables. Process step (a) was carried out at temperature of 50-75° C. and process step (b) was carried out at temperature of 110-160° C.

A relationship was found between the diameter and the aesthetic effect produced. It was particularly noted that maximum flatting, and maximum soft touch are obtained by using smaller diameter spheres. Tab. 1 summarises the results obtained when conducting experiments with transparent micro spheres of various diameters.

When coloured microspheres are used, interesting chromatic effects can also be obtained. Specifically, by mixing microspheres of various colours, surfaces can be obtained that are not the same as one would expect when mixing the colours of the particles, as these colours remain separate. In other words the colours are not combined. Tab. 2 summarises the results obtained when conducting experiments with coloured microspheres of various diameters.

As far as the coated particles are concerned, experiments were carried out on some formulations containing polyurethane/polyurea type microspheres covered with carriers chosen among the types indicated. The formulations tested and the results obtained are shown in tab. 3.

TABLE 1
Choice criterion for transparent Decosphaera particles

| | Diameter | | |
|---|---|---|---|
| Type of particle | [micrometer] | Optical effect | Tactile effect |
| Decosphaera ® TR 7 | 5-7 | Greatest opacity | Soft touch |
| Decosphaera ® TR 15 | 12-17 | Goodt opacity | Soft touch but |
| | | | lightly culrled |
| Decosphaera ® TR 90 | 55-75 | Poor opacity | Curled touch |

TABLE 2
Choice criterion for coloured Decosphaera ® particles

| | Diameter | | |
|---|---|---|---|
| Type of particle | [micromater] | Optical effect | Tactile effect |
| Decosphaera ® TR 15-18 in deep | 12-20 | Greatest opacity and and smooth | Soft touch but |
| black, yellow oxide, red oxide, blu | | multi-color effect (no additive | ligthly curled |
| phthale, pure white, vivid yellow and | | sum of colors) | |
| vivid red color | | | |
| Decosphaera ® TR 90 in white and | 55-75 | Poor opacity and rough multicolor | Curled touch |
| deep black color | | effect (no additive sum of colors) | |

TABLE 3
Examples of compositions

| | CARRIER 1 | | CARRIER 2 | | CARRIER 3 | | Particles | | Effectiveness | |
|---|---|---|---|---|---|---|---|---|---|---|
| Formula | Name | % | Name | % | Name | % | Name | % | Opacita | Soft touch |
| 1 | Low density | 22.8 | Terpene Phenolic | 7.2 | — | — | Decosphaera ® | 70 | poor | too higth |
| | Polyethylhene | | Resin | | | | TR 5 F | | | size |
| | omopolymer | | | | | | | | | |
| 2 | Low density | 22.8 | Terpene Phenolic | 7.2 | — | — | Decosphaera ® | 70 | poor | medium |
| | Polyethylhene | | Resin | | | | TR 7 F | | | |
| | omopolymer | | | | | | | | | |
| 3 | Low density | 22.8 | Terpene Phenolic | 7.2 | — | — | Decosphaera ® | 70 | poor | poor |
| | Polyethylhene | | Resin | | | | TR 7 F ES | | | |
| | omopolymer | | | | | | | | | |
| 4 | Polyethylhene | 50 | — | — | — | — | Decosphaera ® | 50 | poor | poor |
| | | | | | | | TR 7 F ES | | | |
| 5 | Modifyed | 50 | — | — | — | — | Decosphaera ® | 50 | poor | poor |
| | Polyethylhene | | | | | | TR 7 F ES | | | |
| | with EVA (11%) | | | | | | | | | |
| 6 | Modifyed | 50 | — | — | — | — | Decosphaera ® | 50 | medium | medium |
| | Polyethylhene | | | | | | TR 7 F ES | | | |
| | with EVA (21%) | | | | | | | | | |
| 7 | Hydrogenated | 50 | — | — | — | — | Decosphaera ® | 50 | poor | poor |
| | Castor Oil | | | | | | TR 7 F ES | | | |
| 8 | Cetyl Palmitate | 50 | — | — | — | — | Decosphaera ® | 50 | excellent | excellent |
| | | | | | | | TR 7 F ES | | | |
| 9 | Cetyl Palmitate | 20 | Isooctyl | 20 | Polyethylhene | 10 | Decosphaera ® | 50 | excellent | excellent |
| | | | Palmitate | | | | TR 7 F ES | | | |
| 10 | Isooctyl | 20 | Cetyl Palmitate | 30 | — | — | Decosphaera ® | 50 | excellent | excellent |
| | Palmitate | | | | | | TR 7 F ES | | | |

What is claimed is:

1. Method for flatting moulded thermoplastic polymers parts comprising the steps of:
a) mixing a compound (1) selected from the group consisting of thermoplastic materials in powder form along with a compound (2) selected from the group consisting of matting agent particles selected from the group consisting of thermoplastic polymers and thermosetting polymers; the said matting agents being coated with a carrier and the said mixing being carried out at a temperature at which no melting of any of the said compounds takes place; and
b) heating the mixture obtained in step (a) at least up to the temperature of melting of said compound (1), but less than the matting agent;
provided that the carrier is selected from compounds having a melting temperature of at least 30° C. below compound (1) and the matting agent is selected from compounds having a melting temperature higher than compound (1).

2. The method according to claim 1, characterised by the fact that the matting agent particles are selected from the group consisting of polyurethane, polyurea, poly(urethane-urea), and mixtures thereof.

3. The process according to claim 1, characterised by the fact that the said matting agents made of thermoplastic polymers have a melting or decomposition point equal to or higher than 140° C.

4. The process according to claim 1, characterised by the fact that compound (1) is selected from the group consisting of ethylene polymers, styrene polymers and acrylic polymers.

5. The process according to claim 1, characterised by the fact that compound (1) is selected from the group consisting of LDPE, EVA copolymers, HIPS homopolymer, ABS copolymers and SAN copolyemers.

6. The method according to claim 1, characterised by the fact that the said carrier is selected from the group consisting of:
(i) α-olefin polymers, in particular ethylene polymers;
(ii) styrene polymers, such as SAN and ABS copolymers, and acrylic copolymers;
(iii) mono- and polyesters of saturated or unsaturated C₄-C₃₀ fatty acids with branched or linear C₁-C₂₀ alcohols; and
(iv) mixtures thereof.

7. The method according to claim 1, characterised by the fact that that said carrier is selected from the group consisting of:
LDPE, VLDPE and copolymers of ethylene with at least one comonomer selected from the group consisting of: vinyl acetate, acrylate esters, such as methyl acrylate and butyl acrylate; and
amorphous or low crystalline isotactic polypropylene as well as its copolymer with other α-olefins, such as ethylene, butene-1.

8. The method according to claim 1, characterised by the fact that the said carrier is selected from the group consisting of EVA copolymers containing from 20-35 wt % of vinyl acetate.

9. The method according to claim 1, characterised by the fact that the said carrier is a mono- and polyester selected from the group consisting of diethyl adipate, dioctyl adipate, ethyl citrate, octyl palmitate, myristyl palmitate, cetyl stearyl palmitate, isooctyl palmitate, purified castor oils, hydrogenated castor oils, olein, stearine, triglycerides.

10. The method according to claim 1, characterised by the fact that:
compound (1) is selected from the group consisting of ethylene polymers, particularly amorphous ethylene homopolymers, more particularly low density polyethylene;
matting agent is selected from the group consisting of polyurethane having a ratio of soft segments to isocyanates of 1:50, preferably 1:30; and
carrier is selected from the group consisting of mono- and polyesters of saturated or unsaturated C₄-C₃₀ fatty acids with branched or linear C₁-C₂₀ alcohols and ethylene copolymers, in particular EVA copolymers, having the comonomers ranging from 20 to 35 wt % for example, and their mixtures; and
characterised by the fact that process step (a) is carried out at a temperature ranging from 50 to 75° C. and process step (b) is carried out at a temperature ranging from 110 to 120° C.

11. The method according to claim 1, characterised by the fact that:
compound (1) is ethylene copolymers, in particular EVA copolymers, having the comonomers ranging from 4 to 35 wt % for example;
matting agent is a polyurethane having a ratio of soft segments to isocyanates of 1:50, preferably 1:30; and
carrier Is selected from the group consisting of mono- and polyesters of saturated or unsaturated C₄-C₃₀ fatty acids with branched or linear C₁-C₂₀ alcohols; and
characterised by the fact that process step (a) is carried out at a temperature ranging from 50 to 75° C. and process step (b) is carried out at a temperature ranging from 120 to 230° C.

12. The method according to claim 1, characterised by the fact that:
compound (1) is a styrene polymer;
matting agent is selected from the group consisting of polyurethane/polyurea particles having a ratio of soft segments to isocyanate of 1:15, preferably 1:10; and
carrier Is selected from the group consisting of mono- and polyesters of saturated or unsaturated C₄-C₃₀ fatty acids with branched or linear C₁-C₂₀ alcohols; and
characterised by the fact that process step (a) is carried out at a temperature ranging from 50 to 75° C. and process step (b) is carried out at a temperature ranging from 120 to 220° C.

13. The method according to claim 1, characterised by the fact that compound (1) is selected from the group consisting of HIPS homopolymers, ABS and SAN copolymers.

14. The method according to claims 1, characterised by the fact that the said matting agent is in particles having sizes are between 1 and 300 microns.

15. The method according to claims 1, characterised by the fact that the matting agents are pigmented.
